(19) United States
(12) Patent Application Publication
(10) Pub. No.: US 2009/0292438 A1
(43) Pub. Date: Nov. 26, 2009

(54) Circuit Detecting Combustion-Related Variables

(76) Inventors: Hubert Nolte, Hoexter (DE); Martin Herrs, Hoexter (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/922,073

(22) PCT Filed: Mar. 7, 2006
(86) PCT No.: PCT/EP2006/002077

§ 371 Date: Dec. 12, 2007

(30) Foreign Application Priority Data
Jun. 13, 2005 (DE) 10 2005 027 396.3
Jun. 28, 2005 (DE) 10 2005 030 481.8
Sep. 14, 2005 (DE) 10 2005 044 030.4

(51) Int. Cl. F02D 45/00; F02P 15/00; H01T 13/00; F02P 3/05; G01M 15/04

(52) U.S. Cl. 701/101; 123/634; 123/169 R; 123/623; 73/114.67

(57) ABSTRACT

In a circuit for and a method of detecting combustion-relevant variables in an internal combustion engine an ionization signal is determined in dependence on the flame. To improve the accuracy of detection the ionisation measurement circuit is connected to the ignition electrode and decoupled from the ignition coil by way of a decoupling means. In the method a voltage potential is built up in a measurement voltage storage unit in the ignition phase with an ignition current. During at least one measurement phase the voltage potential is applied by way of a measurement resistor to an ignition electrode, wherein the ignition voltage is decoupled from the measurement voltage storage unit or from the measurement resistor when the voltage falls below a threshold voltage.

### CROSS-REFERENCE TO RELATED APPLICATIONS

This is a national phase application of International Application No. PCT/EP2006/002077, filed Mar. 7, 2006 which claims priority of German Application No. 10 2005 027 396.3, filed Jun. 13, 2005, No. 10 2005 030 481.8, filed Jun. 28, 2005 and 10 2005 044 030.4, filed Sep. 14, 2005, the complete disclosures of which are hereby incorporated by reference.

### a) FIELD OF THE INVENTION

The invention concerns a circuit for detecting combustion-relevant variables in the combustion phase of an internal combustion engine, in particular a four-stroke engine, by means of an ignition electrode supplied with an ignition pulse, and a method of determining combustion-relevant variables of a combustion process in internal combustion engines.

### b) DESCRIPTION OF THE RELATED ART

Methods of the kind referred to above are described in EP 0 801 226 A2 and DE 196 49 278 A1.

Detailed information about characteristics variables of the combustion process can be derived by means of ionization measurements in the combustion chamber of internal combustion engines. These are, inter alia, the air ratio of combustion, the beginning of combustion, the pressure variation during combustion, retarded ignition, pinking, ignition misfires or the like.

For that purpose a sensor element is usually arranged at a representative position in the combustion chamber. Typically this involves an electrically conductive element which is insulated with respect to the potential of the combustion chamber by means of an insulator.

A measurement voltage is applied by way of a signal line and, in dependence on the combustion pattern, a current flows through the ionized combustion gases from the sensor element to the combustion chamber ground. Such a current is subsequently evaluated.

Ionization measurement devices are typically connected into the ignition voltage circuit of an internal combustion engine. In that case the ignition circuit comprises an ignition coil unit, a spark plug and an electrical connection between the two. The ignition coil unit can advantageously include the electronic power system for connecting the primary coil to the energy supply for triggering the ignition spark.

In that case the energy for implementing ionization measurement is either taken from the ignition circuit upon ignition or is supplied by an external energy source. An ionization current causes a voltage drop at a measurement resistor and is passed by way of a measurement line to the units of the engine management, which evaluate and further process the ionization pattern. Such a structure however suffers from the disadvantage that an additional line is required.

Evaluation of ionization signal patterns in the case of discontinuous combustions in internal combustion engines (four-stroke engines, diesel, and so forth) for ascertaining engine parameters such as air ratio, retarded combustion, ignition misfires, pinking, opt. ignition time, has hitherto been effected by way of functional analysis of the ion current configuration in terms of “geometrical” data such as maximum, position of the maximum, integral, centroid, gradient, maximum of the gradient, and so forth.

Systematic disturbance influences eclipse the evaluation of the geometrical data, such as for example burning away of the spark plug, spark plug fouling, different quality of fuel and thus conductivity of the flame, stochastic fluctuations in the signal height due to differing propagation of the flame front in the combustion chamber, influences arising out of the ignition residual voltage (also dependent on the engine load), and influences of aspects other than the engine parameter to be ascertained.

Evaluation can be only limitedly improved, in respect of the desired parameter, by means of calibration and weighting functions.

### OBJECT AND SUMMARY OF THE INVENTION

The primary object of the invention is to improve the accuracy of detection of the ionization signal.

That object is attained by a circuit in accordance with the invention for detecting combustion-relevant variables in a combustion phase of an internal combustion engine, in particular, a four-stroke engine, wherein the combustion is triggered by an ignition electrode supplied with an ignition pulse, comprising an ionization measurement circuit having at least one measurement resistor. The ionization measurement circuit has at least one measurement voltage storage unit which is coupled to the ignition electrode and is decoupled by way of decoupling means from an ignition voltage generating device of the internal combustion engine. The object is also attained by a method in accordance with the invention of detecting combustion-relevant variables of a combustion process in a combustion phase of an internal combustion engine comprising the steps of initiating individual combustion processes by an ignition pulse, ascertaining the combustion relevant variables in dependence on an ionization signal influenced by the flame, building up a voltage potential in a measurement voltage storage unit in the ignition phase by an ignition current, and applying a voltage potential in at least one measurement phase by way of a measurement resistor to an ignition electrode. The ignition voltage is decoupled from the measurement voltage storage unit or the measurement resistor in respect of the measurement voltage when the voltage falls below a threshold voltage.

In this case the ionization measurement circuit is connected to the ignition electrode and decoupled from the ignition coil by way of decoupling means. In the ignition phase, a voltage potential is built up in a measurement voltage storage unit with an ignition current and in at least one measurement phase the voltage potential is applied to an ignition electrode by way of a measurement resistor, wherein the ignition voltage is decoupled from the measurement voltage storage unit or from the measurement resistor when the voltage falls below a threshold voltage.

In accordance with an aspect of the present invention, the ionization measurement circuit is connected between the ignition voltage-carrying connection of the secondary side of the ignition transformer and the ignition electrode and connected between the reference potential and between the connection, associated with the reference potential, of the secondary side of the ignition transformer is an electronic switch which is switched to a conducting condition by a control unit during the ignition pulse for passing the ignition signal and which is switched to the blocking condition at least during the ionization measurement phase. A measurement voltage storage circuit is connected between the ignition voltage-carrying connection of the secondary side of the ignition transformer and the ignition electrode and an electronic switch is connected between the reference potential and a connection, associated with the reference potential, of the secondary side of the ignition transformer. The circuit can be integrated into an ignition transformer. The circuit has an ionization measurement circuit which is connected to the ignition electrode and is decoupled from the ignition transformer by way of decoupling means. There is proposed a method in which a voltage potential is built up in a measurement voltage storage unit in the ignition phase with an ignition current, wherein in at least one measurement phase the voltage potential is applied to an ignition electrode by way of a measurement resistor, wherein the ignition voltage is decoupled from the measurement voltage storage unit or the measurement resistor when the voltage falls below a threshold voltage.

The ignition residual voltage is decoupled from the ionization measurement circuit with an electronic switch which is switched into a conducting condition during the ignition pulse to pass the ignition signal and which subsequently to the ignition pulse is switched into a non-conducting condition, for ionization measurement. That switch is actuated by an ignition control unit which controls the progress of ignition.

The method can advantageously also be used in conjunction with an ignition spark control. In that case the ignition voltage control unit controls switching-off of the ignition pulse after a predetermined duration, by the primary winding of the ignition transformer being loaded in low-impedance relationship by a short-circuit. The voltage, which occurs upon the reduction in the residual energy of the ignition transformer, on the secondary side of the ignition transformer, is not passed to the ionization measurement circuit through the switched-off electronic switch.

In accordance with a further aspect of the invention, a defined ignition energy is predetermined by a predetermined first burning duration of an ignition spark. After the end of burning of the first ignition spark, measurement of ionization in the combustion chamber of the internal combustion engine is effected to ascertain ionization measurement values. They are compared to predetermined values and, in the case of excessively low ionization which corresponds to a fuel-air mixture which has not yet ignited, a second ignition voltage is applied to the spark plug. After the end of burning of the second ignition spark ionization is measured again and a comparison is effected to ascertain whether ignition in the combustion chamber has occurred. Therefore, after the end of an ignition spark, a check is made to ascertain whether ignition has already taken place and the mixture is burning. The cycle of producing an ignition spark and ionization measurement with comparison is performed until an ionization value which corresponds to an ignited mixture is measured.

By means of cyclically implemented ignition, the ignition energy which is fed to the combustion chamber can be fed at defined intervals. Advantageously the ignition energy is time-controlled, that is to say the ignition spark burns for a predetermined period of time and is then interrupted. After the end of burning of the ignition spark, a measurement is immediately implemented by means of an ionization measurement circuit, to ascertain whether the mixture is fired. For that purpose ionization measurement values are compared to ionization reference values and, in dependence on the difference, it is decided whether and it is recognized whether combustion is taking place. If combustion is occurring, ionization is advantageously further measured in order further to track burning of the mixture and to ascertain further combustion-relevant parameters such as pinking and the lambda value. If the mixture fails to burn or if it does not burn completely, ignition is effected again and a defined ignition energy is again fed to the combustion chamber, this advantageously being effected in time-controlled fashion so that the ignition spark burns again for a predetermined period of time. That is again followed by ionization measurement in order to ascertain whether the mixture is or is not burning. The cycle of ignition with alternate ionization measurement is effected until the mixture is ignited or the combustion cycle is concluded. In that respect the spark plug serves as an ignition electrode and as a measurement sensor.

In an advantageous configuration of the invention no further ignition spark is produced after secure combustion has occurred and ionization in the combustion chamber is further measured in order to detect further engine parameters such as pinking and the lambda value. If ionization should present an inadmissible configuration and collapse or if deviations should occur, in the comparison with predetermined values, which indicates premature extinction of the flame, an ignition voltage is applied again in order once again to ignite the mixture.

Accordingly, to ignite the mixture, the required energy is afforded as required and a check is made by means of an ionization signal to ascertain whether ignition has occurred. In an advantageous embodiment the burning duration is controlled as a parameter for the ignition energy and the burning duration is minimized. For that purpose the procedure advantageously involves ascertaining how long the first ignition spark must burn in order to achieve reliable ignition under various engine operating conditions. That is effected with self-adaptive methods and advantageously in a microprocessor.

Furthermore the method and the arrangement provide that it is possible to use an ignition coil with a smaller working storage capacity as the first ignition spark does not have to be designed for all ignition operations over the entire working range of the machine. It is also advantageous for the ignition spark to be terminated immediately after ignition has occurred in order to quickly obtain signals about the burning pattern such as lambda value, pinking and retarded combustion, by means of the following ionization measurement operation. For that purpose the ionization signal is further measured after the last ignition pulse.

In accordance with a further aspect of the invention passing the ionization signal to the evaluation unit involves employing the same line which carries the signal for triggering the electronic power system for initiating the firing pulse. The ionization signal is connected together in the ignition unit by way of suitable means with the triggering signal for ignition, and both signals can thus be passed by way of one line. In the unit which controls the ignition pulse and which subjects the ionization signal to further processing the signals are again separated by way of suitable means and processed separately from each other.

The invention concerns the concept of determining the similarity of the ionization signal pattern which is currently being measured, with various stored ionization signal patterns which are characteristic in respect of given operating points or engine parameters. The value of the engine parameter is then calculated from the relationship of the degrees of similarity ascertained. Thus the method provides that it is not just one or a few geometrical variables of the ionization signal pattern that is or are ascertained, but the whole signal configuration is assessed.

The embodiments by way of example of the present invention and advantages of the invention are described in greater detail hereinafter with reference to the accompanying drawings.

### BRIEF DESCRIPTION OF THE DRAWINGS

In the drawings:

FIG. 1 shows a schematic circuit diagram of an engine control in accordance with a first embodiment;

FIG. 2 shows a schematic circuit diagram of a circuit for ignition and ionization measurement in accordance with a second embodiment;

FIG. 3 shows a schematic circuit diagram of a circuit for ignition and ionization measurement in accordance with a third embodiment;

FIG. 4 shows a schematic circuit diagram of a circuit for ignition of combustion phenomena in accordance with a third embodiment;

FIG. 5 shows a circuit diagram of a circuit for ignition in an internal combustion engine in accordance with a fourth embodiment;

FIG. 6 shows a circuit diagram of an engine electronic unit in accordance with a fifth embodiment;

FIG. 7 shows a circuit diagram of a coupling means of FIG. 5 in accordance with a seventh embodiment;

FIG. 8 shows a circuit diagram of an ignition unit in accordance with an eighth embodiment;

FIG. 9 shows a diagrammatic view of a spark plug connector in accordance with a ninth embodiment;

FIG. 10 shows a diagrammatic view of a plurality of spark plugs and an ignition distributor in accordance with a tenth embodiment;

FIG. 11 shows a diagrammatic view of a plurality of spark plugs and an ignition distributor in accordance with an eleventh embodiment;

FIG. 12 shows a diagrammatic view of a plurality of spark plugs and an ignition distributor in accordance with a twelfth embodiment;

FIG. 13 shows a diagrammatic view of a structure of a spark plug connector in accordance with a thirteenth embodiment;

FIG. 14 shows a diagrammatic view of a circuit for the evaluation of ionization signal configurations in accordance with a fourteenth embodiment;

FIG. 15a shows the relative signal amplitude of reference curves and the measured ionization curve IO;

FIG. 15b shows the relative proportions of the measured ionization curve IO in relation to the respective reference signal configurations;

FIGS. 16a and 16b show a graph of reference signal configurations and an ionization signal as well as a graph of an association of the parameters; and

FIGS. 17a and 17b show a graph of reference curves and a measured ionization signal as well as an association of the parameters.

### DESCRIPTION OF THE PREFERRED EMBODIMENTS

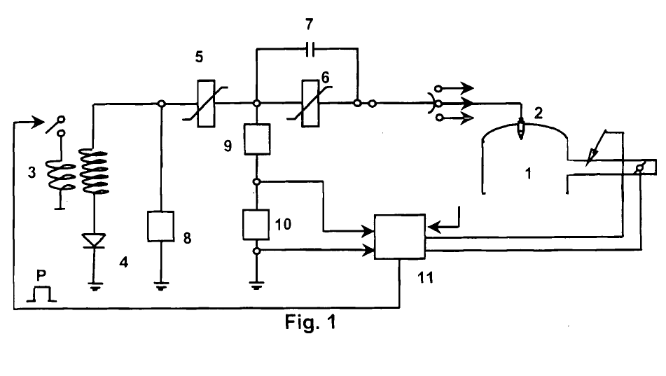

FIG. 1 shows a circuit diagram of a circuit for ignition and for ionization measurement in accordance with a first embodiment. At least one spark plug 2 is arranged in a combustion chamber 1 of an internal combustion engine.

An ionization measurement circuit is decoupled from the ignition coil 3 by decoupling means 5, 8. The ignition current flowing through the spark plug during the spark flash-over passes the decoupling means 5, 8 and charges up the measurement voltage storage means 6, 7 in the ionization measurement circuit. After termination of the spark flash-over the decoupling means 5, 8 decouple the ionization measurement circuit comprising the capacitor 7, the varistor 6, a series resistor 9 and a measurement resistor 10, from the ignition residual voltage.

For that purpose the ionization measurement circuit has at least one measurement voltage storage unit 6, 7, an ionization measurement resistor 9, 10 and the spark plug 2 which is arranged in the combustion chamber 1 and which is used as an ionization sensor.

The measurement voltage storage unit 6, 7 advantageously comprises a parallel circuit of an electrical energy storage means, in particular a capacitor 7, and a voltage-limiting component, in particular a varistor 6 or a Zener diode.

In the phase in which the ignition current is flowing the measurement voltage storage unit 6, 7 is charged up or re-charged by way of the ignition current, and the charging voltage is stabilized by means of the voltage-limiting component 6 to the threshold value thereof.

In the subsequent combustion phase the charged measurement voltage storage unit 6, 7 is applied to the ignition electrode 2 by way of a measurement resistor combination 9, 10. A voltage drop proportional to the ionization current can be taken off as an ionization signal at the measurement resistor 10 and subjected to further processing.

An advantageous configuration of the measurement resistor combination 9, 10 is the series connection of resistors 9, 10 for increasing overall impedance, in which respect the ionization signal is advantageously taken off across the resistor 10 connected to circuit ground.

That ionization signal is subsequently subjected to further processing in the evaluation unit 11. Here it can also be evaluated in respect of combustion-relevant variables.

A decoupling means decouples the influence of the ignition residual voltage from the ionization measurement circuit, insofar as the ionization measurement circuit is advantageously separated from the ignition coil by way of a voltage-limiting component 5. In addition it is also possible for components to be connected in parallel with the secondary or primary side of the ignition coil, which accelerate decay of the ignition residual voltage. That is advantageously effected by the resistor 8.

The diode 4 connected in series with the secondary side of the ignition coil blocks a positive potential at the ignition coil output, which without the diode would already occur upon application of the primary voltage to the primary winding of the ignition coil 3, which however is undesirable.

The first embodiment concerns a circuit for detecting combustion-relevant variables in a combustion phase of an internal combustion engine. The combustion phase is triggered off by an ignition electrode which is supplied with an ignition pulse. The circuit has an ionization measurement circuit with at least one measurement resistor 8, 9. The ionization measurement circuit has a measurement voltage storage unit 6, 7. The storage unit is coupled to the ignition electrode 2 and is decoupled by way of a decoupling means from the ignition coil of the internal combustion engine.

The measurement voltage storage unit has an electrical energy-storing component (a capacitor) and a voltage-limiting component (a varistor, a Zener diode, a spark gap or a gas arrester or eliminator).

The first embodiment also concerns a method of detecting combustion-relevant variables in a combustion process of an internal combustion engine. The combustion processes are initiated by an ignition pulse. The combustion-relevant variables are ascertained in dependence on an ionization signal influenced by the flame. A voltage potential is built up in a measurement voltage storage unit in the ignition phase by an ignition current. The voltage potential is applied in at least one measurement phase to an ignition electrode by way of a measurement resistor, in which case the ignition voltage decouples the measurement voltage storage unit or the measurement resistor from the measurement voltage when the voltage falls below a threshold value.

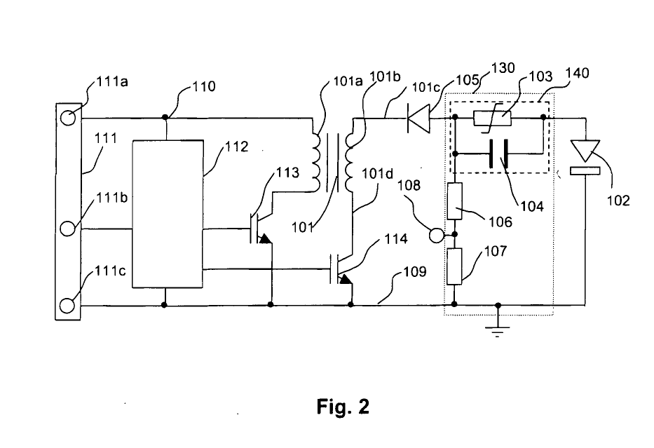

FIG. 2 shows a schematic circuit diagram of a circuit for ignition and ionization measurement in accordance with a second embodiment. FIG. 2 shows a connection 111 which connects the ignition and ionization measurement circuit to the electronic engine control system. The connection 111a is connected to the positive supply voltage, the connection 111c is connected to ground potential and the connection 111b is connected to the control line for ignition pulse triggering. The ignition control unit 112 is connected to the connection 111 and forms the signal for actuation of the power semiconductor 113 which switches the primary winding 101a of the ignition transformer 101 to the supply voltage by way of the paths 110 and 109. When the ignition control unit 112 switches off the power semiconductor 113 again, the ignition voltage is induced on the secondary winding 101b of the ignition transformer 101.

At least during the ignition pulse the ignition control unit 112 switches the electronic switch 114 formed by a semiconductor into a conducting condition so that the ignition current can pass it. The ignition current passes the decoupling component 105 which is in the form of a diode in the forward direction and charges up the measurement voltage storage circuit 140 which is formed by a voltage-ionization component 103 in parallel with a capacitor 104. The measurement voltage storage circuit 140 corresponds to the measurement voltage storage unit 6, 7 of the first embodiment. The ignition current further passes the ignition electrode 102 which is a component part of a spark plug arranged in a combustion chamber of an internal combustion engine and flows by way of the ground path 109 and the electronic switch 114 back to the secondary winding of the ignition transformer. After termination of the spark flash-over at the ignition electrode 102 and after the ignition current breaks down the ignition control unit 112 switches the electronic switch 114 formed by a semiconductor into a blocking condition so that the influence of the residual energy still remaining in the ignition transformer 101 on the ionization measurement operation which now follows is suppressed and thus the ignition residual voltage is decoupled from the ionization measurement circuit 130.

Ionization measurement is implemented in the ionization measurement circuit 130 in which the measurement voltage storage circuit 140 which is charged up by the ignition pulse applies the measurement voltage to the ignition electrode 102 by way of the ionization measurement resistors 106 and 107.

In the combustion phase the plasma in the combustion chamber between the ignition electrode 102 and the combustion chamber ground becomes electrically conductive and an ionization current flows, which can be measured as a voltage drop across the resistors 106 and 107. A voltage proportional to the ionization current can be taken off at the connection 108 during the ionization measurement phase, while a signal proportional to the ignition voltage can be taken off at the connection 108 during the ignition process.

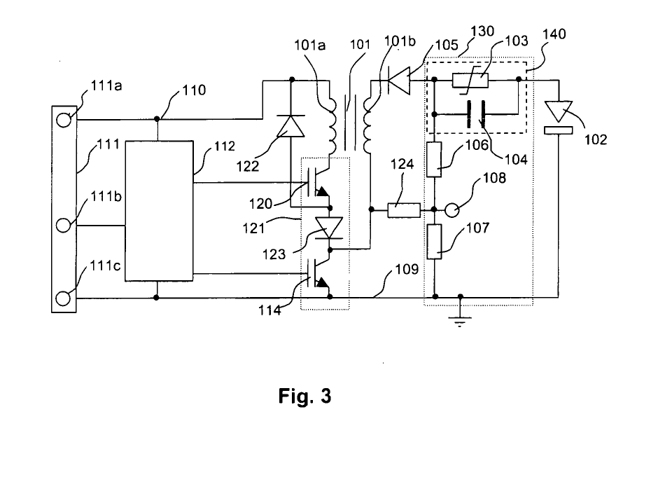

FIG. 3 shows a schematic circuit diagram of an ignition and measurement circuit in accordance with a third embodiment. FIG. 3 shows in particular a circuit diagram with alternative spark control. By means of a spark control system, the residual energy in the ignition transformer 101 can be discharged during ignition by a sink connected to the ignition transformer 101, in such a way that the ignition spark is extinguished. Accordingly a defined ignition energy is fed to the combustion chamber 161 for ignition of the mixture, with a defined ignition spark burning duration. In an advantageous configuration two power semiconductors 120 and 114 are connected in the primary current path 121 of the ignition transformer 101.

For the input of energy into the ignition transformer 101 both power semiconductors 120 and 114 are switched into a conducting condition by the ignition control unit, and in that situation the primary current also passes the diode 123 disposed in the primary current path 121. Subsequently thereto, to produce the ignition voltage, the power semiconductor 120 is switched into a non-conducting condition, the secondary winding of the ignition transformer is connected to reference potential by the power semiconductor 113 which is switched into a conducting condition, and the induced ignition voltage is passed to the ignition electrode 102 by way of the ionization measurement circuit 130. To terminate ignition spark burning the power semiconductor 114 is switched into the non-conducting condition by the ignition control unit 112 and the power semiconductor 120 is switched into the conducting condition thereby.

The diode 122 and the power semiconductor 120 form a short-circuit for the residual energy of the ignition transformer 101. The non-conducting power semiconductor 114 then decouples the ignition transformer 101 from the ionization measurement circuit 130 and the following ionization measurement becomes very precise.

The resistor 124 compensates for signal falsification due to parasitic capacitances in parallel relationship with the switching path of the power semiconductor 114.

In an advantageous configuration upon actuation of the power semiconductors 114 and 120 by the ignition control system 112, blocking of the power semiconductor 114 occurs in the spark switch-off phase a short period of time prior to opening of the power semiconductor 120; in that case the parasitic capacitance of the power semiconductor 114 is pre-charged.

The second and third embodiments concern a circuit for the detection of combustion-relevant variables of an internal combustion engine. The circuit has an ionization measurement device with at least one ionization measurement resistor. A measurement storage circuit is coupled between a first connection of the secondary side of the ignition transformer, which carries the ignition voltage, and the ignition electrode. An electronic switch is coupled between a reference potential and a second connection, associated with the reference potential, of the secondary side of the ignition transformer.

A further decoupling device can be coupled between the first connection of the secondary side of the ignition transformer and the ionization measurement circuit. The decoupling device can have a diode, a Zener diode and/or a varistor.

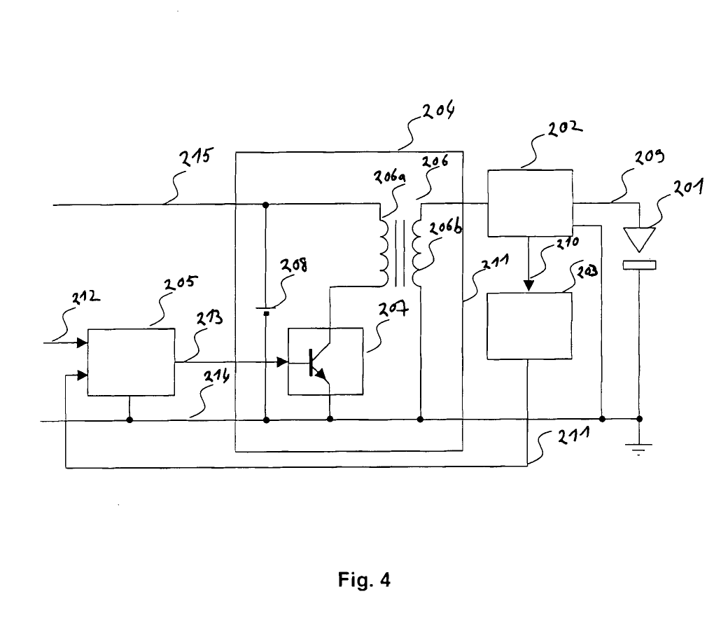

FIG. 4 shows a block circuit diagram of the device for igniting combustions, in accordance with a fourth embodiment. For triggering off ignition an ignition triggering demand is coupled to a means 205 for controlling the ignition voltage configuration, by way of a signal line 212, for triggering ignition. By way of the signal line 213 a control signal is passed from the means 205 for controlling the ignition voltage configuration, for switching a semiconductor switch 207 in the means 204 for producing the ignition voltage. When the semiconductor switch 207 is switched on an ignition voltage supply 208 is connected to a primary winding 206a of an ignition transformer 206. When the semiconductor switch 207 is switched off again, controlled by the control signal, the ignition voltage is induced in a secondary winding 206b of the ignition transformer 206. The ignition voltage passes an ionization detector 202 and goes by way of a connection 209 to the spark plug 201 where spark flash-over occurs for igniting the mixture in the combustion chamber. After the termination of the spark flash-over the ionization detector 202 measures the ionization in the combustion chamber, which occurs due to flame formation. The measurement signal goes by way of a line 210 to the evaluation unit 203 for ionization measurement values. Here the arrangement assesses whether the mixture in the combustion chamber was ignited. The basis for assessment is a comparison of the measured ionization signal after termination of the spark flash-over at the spark plug 201 with ionization reference values. The result of the assessment process is passed by way of a line 211 to the means 205 for controlling the ignition voltage configuration. If the mixture was not ignited, further ignition is triggered in the same working cycle by the means 205 for controlling the ignition voltage configuration. If the mixture has been ignited no further ignition is triggered in the same working cycle by the means 205 for controlling the ignition voltage configuration.

The fourth embodiment relates to a device for igniting combustion processes in internal combustion engines. The arrangement has a spark plug for ignition of the combustion process, the spark plug being used as a sensor for ionization caused by combustion. An ionization measurement circuit is provided for the measurement of ionization in the combustion chamber, and there is an evaluation unit for the ionization values, as well as means for producing the ignition voltage. A means for controlling the ignition voltage configuration is connected to the ionization evaluation unit and the ignition voltage configuration is regulated in dependence on the ionization values.

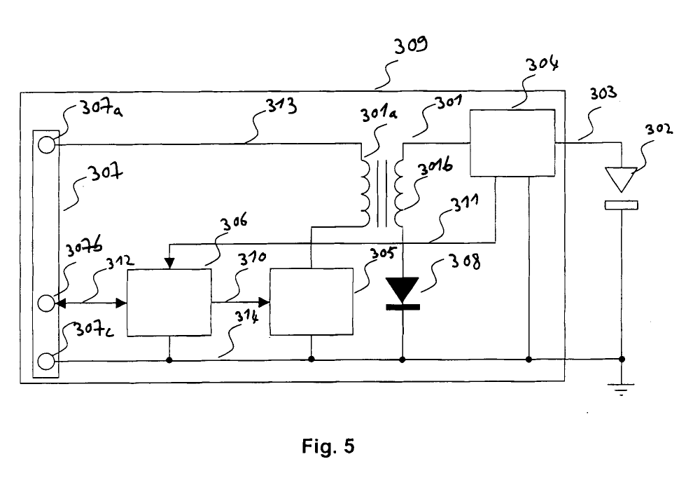

FIG. 5 shows a block circuit diagram of a device for ignition and the generation of the ionization signal in accordance with a fifth embodiment. This device has an ignition coil 301, an ionization detector 304, an electronic power ignition unit 305, a coupling means 306 and a diode 308. The device is further connected to a spark plug 302 by way of a connecting line 303. The device further has a connector plug 307 with three poles 307a, 307b and 307c.

The ignition coil 301 comprises the primary winding 301a and the secondary winding 301b. At its one connection the primary winding 301a is connected to the voltage supply line 313 which can usually carry the potential of the positive terminal of the motor vehicle on-board network system. The primary winding 301a is connected at its second connection to the electronic power ignition unit 305. The ignition unit 305 has a semiconductor switch which, upon a trigger pulse on the ignition triggering line 301, switches the second connection of the primary winding 301a to voltage supply ground 314 which usually carries the potential of the negative terminal of the motor vehicle on-board network system.

The ignition coil 301 acts as a transformer, that is to say induced in the secondary winding 301b is the ignition voltage which is passed to the ionization detector 304. The diode 308 connected to the second connection of the secondary winding 301b causes blocking of a component of the ignition voltage, which is unwanted in terms of potential.

The ionization detector 304 passes the ignition pulse to the spark plug 302 by way of a connecting line 303. The ionization detector 304 in the fifth embodiment substantially corresponds to the ionization measurement circuit of the first, second or third embodiment. The return flow of the ignition current is by way of the voltage supply ground 314. After the ignition current breaks down the ionization detector 304 applies a measurement voltage to the spark plug 302. In dependence on the combustion process at the spark plug 302 an ionization current flows from the ignition electrode of the spark plug 302 to the combustion chamber ground. An ionization measurement voltage is generated in the ionization detector 304 proportionally to the ionization current and is applied to the ionization measurement line 311. Both the ionization measurement line 311 and also the ignition triggering line 310 are connected to the coupling means 306. The two signals are brought together in the coupling means 306 on the ignition/ionization line 312. The coupling means 306 selectively couples the ionization measurement line 311 and the ignition triggering line 310 to the ignition/ionization line 312. The ignition/ionization line 312 represents the signal line with which the engine management system of an internal combustion engine both triggers the ignition pulse and also receives the ionization signal fed thereto.

When the engine management system sends a trigger pulse for triggering ignition, it is passed by the coupling means 306 by way of the ignition triggering line 310 to the electronic power system 305. An unwanted signal change due to connecting the ionization detector 304 by way of the ionization measurement line 311 is not to occur. If the ionization detector 304 detects an ionization current and passes the ionization measurement voltage by way of the ionization measurement line 311 to the coupling means 306, the coupling means 306 must pass that voltage to the ignition/ionization line 312. An unwanted signal change due to the connection of the electronic power system 305 by way of the ignition triggering line 310 may not occur.

The voltage supply line 313, the voltage supply ground 314 and the ignition/ionization line 312 are connected to the connection plug 307 and occupy the terminals 307a, 307b and 307c.

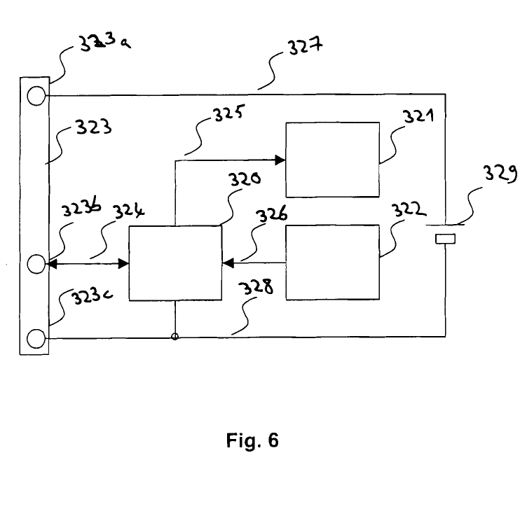

FIG. 6 shows a block diagram of an electronic engine control system of an internal combustion engine in accordance with a sixth embodiment. This electronic engine control unit has an ionization evaluation unit 321, an ignition management unit 322, a second coupling means 320, a connection plug 323 and a voltage supply 329.

By way of a connecting line between the ignition device and the electronic engine system, the connection plug 323 of the electronic engine system 327 is connected to the connection plug 307 of the ignition/ionization unit 309, the terminals with the same letter index are electrically connected together. The voltage supply 329 supplies the connection plug 323 and therewith the ignition unit 309 with voltage by way of the lines 327 and 328.

The ignition/ionization line 324 of the electronic engine system 327 is connected to the coupling means 320 of the electronic engine system. The coupling means 320 of the electronic engine system is further connected by way of the connecting line 326 to the ignition management system 322 and by way of the connecting line 325 to the ionization evaluation system 321.

For ignition purposes the coupling means 320 of the electronic engine system passes the ignition pulse generated in the ignition management system 322 to the connection plug terminal 323b and thus to the ignition unit 309. An ionization measurement voltage from the ignition unit, which is applied to the connection plug terminal 323b, is passed from the coupling means of the electronic engine system 320 by way of the line 325 to the ionization evaluation system 321.

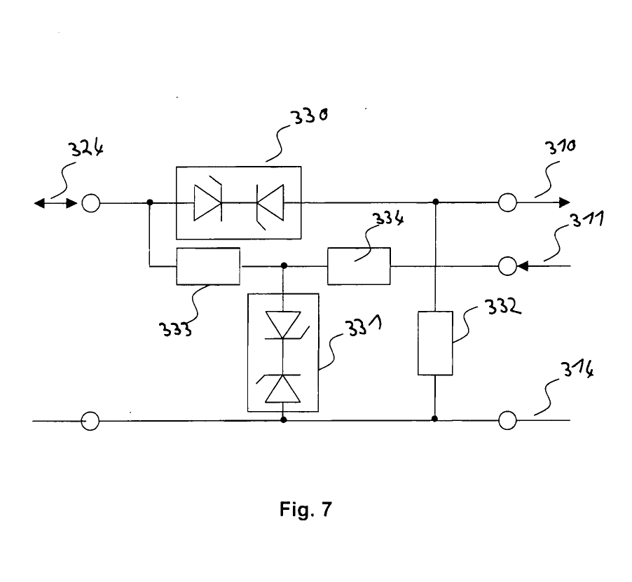

FIG. 7 shows a block circuit diagram of a second coupling means as shown in FIG. 5 in accordance with a seventh embodiment. The coupling means has a first voltage-dependent resistor 330, a second voltage-dependent resistor 331, a first resistor 332, a second resistor 333 and a third resistor 334.

The illustrated lines connected to the coupling means correspond to those shown in FIG. 5. The coupling means 306 itself includes a first path for passing the ignition trigger pulse comprising a first voltage-dependent resistor 330 and a first resistor 332 which is connected to ground. The coupling means 306 further includes a second path for passing the ionization signal comprising the second and third resistors 333 and 334 as well as a voltage-dependent resistor 331 connected to ground.

The two paths are selectively conducting for the signal portions intended for them while they block or not detrimentally influence the signal portions which are not intended for them. In the case of ignition triggering the resistor 333 prevents unwanted damping of the ignition trigger pulse which however can pass the threshold voltage of the voltage-dependent resistor 330 for triggering ignition. In the case of ionization measurement however the threshold voltage of the voltage-dependent resistor 330 prevents unwanted damping of the ionization measurement voltage, that is to say it can pass the resistor combination 333 and 334.

The voltage-dependent resistors 330 and 331 can be in the form of varistors, diodes, Zener diodes or a combination of those components.

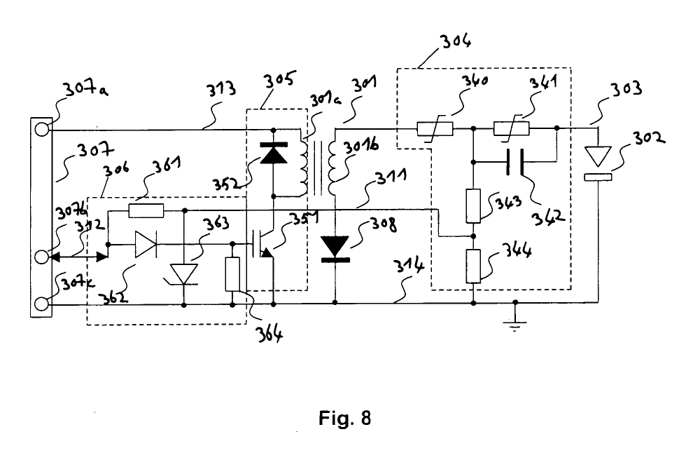

FIG. 8 shows a circuit diagram of an ignition unit in accordance with an eighth embodiment. In this respect the structure of the ignition unit in FIG. 8 corresponds to that of the ignition unit of FIG. 5. The ionization detector 304, the coupling means 306 and the electronic power ignition unit 305 are shown in detail in FIG. 8. The first coupling means 306 has a first resistor 361 and a second resistor 364. The coupling means 306 further has a first diode 362 and a second diode 363. The electronic power ignition unit 305 has a diode 352 and a transistor 351. The ionization detector 304 has a first resistor 343 and a second resistor 344, a capacitor 342 as well as a first voltage-dependent resistor 340 and a second voltage-dependent resistor 341, wherein the measurement voltage storage unit is formed by the capacitor 342 and the voltage-dependent resistor 341 (similarly to the measurement voltage storage unit shown in FIGS. 1, 2 and 3).

The coupling means includes the components 361, 362, 363 and 364. The electronic power system includes the components 351 and 352. The ionization detector includes the components 340, 341, 342, 343 and 344.

The fifth, sixth, seventh and eighth embodiments concern an ignition device for internal combustion engines. The ignition device has an ignition coil for firing a spark plug, an ignition unit for initiating ignition of the ignition coil in accordance with an external ignition trigger circuit from an external engine control unit, an ionization detector for detecting an ionization signal in respect of combustion and for outputting an ionization measurement signal proportional to the ionization signal. The ignition device further has a coupling means for selectively coupling the ionization measurement signal and the ignition triggering signal to an ignition/ionization line which connects the ignition device to an external engine control unit.

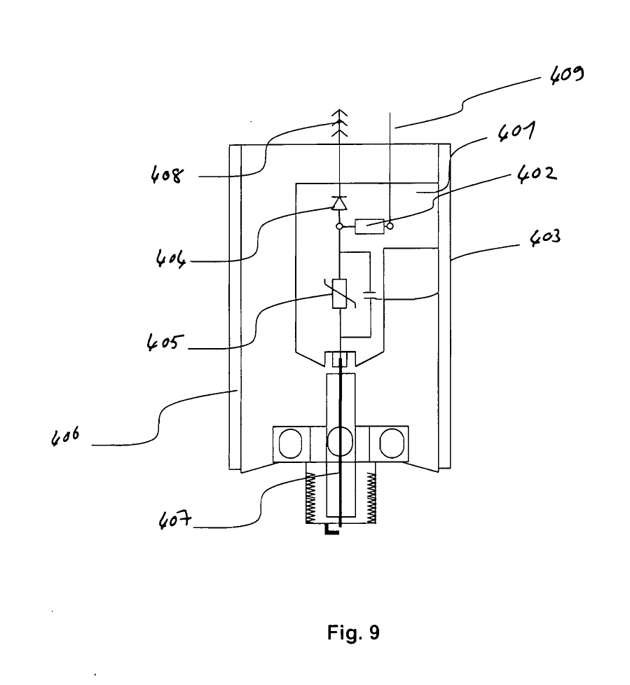

FIG. 9 shows a diagrammatic view of a spark plug connector in accordance with a ninth embodiment. This Figure shows in particular the integration of an ionization measurement circuit in the spark plug connector of an internal combustion engine.

A measuring resistor 402, a capacitor 403, a decoupling component 404 and a voltage-stabilizing component 405 (varistor) are arranged in the spark plug connector 401. The spark plug connector is disposed in a metallic plug housing 406 which serves as shielding in relation to electromagnetic interferences. The capacitor 403 and the voltage-stabilizing component 405 form a measurement voltage storage unit, as has also been described in the preceding embodiments. The circuit shown in FIG. 9 with the measuring resistor 402, the capacitor 403, the decoupling component 404 and the voltage-stabilizing component 405 substantially corresponds to the ionization measurement circuit shown in FIG. 2 or in FIG. 8.

The ignition coil which is not shown in FIG. 9 produces an ignition voltage of the order of magnitude of for example 10-25 KV. By way of the connection 408 the ignition current passes the decoupling component 404 which is in the form of a diode in the forward direction and charges up the parallel-connected measurement voltage circuit which is formed by the voltage-stabilizing component 405 and the capacitor 403. After termination of the spark flash-over the decoupling means 404 decouples the ionization measurement circuit from the ignition coil and prevents the disturbing influence of the ignition residual voltage on ion measurement. In the combustion phase which follows spark burn-away, the charged-up measurement voltage storage unit 403, 405 is applied to the ignition electrode 407 by way of the measurement resistor 402. A voltage drop proportional to the ionization current can be taken off as an ionization signal at the measurement resistor 402 and is passed by way of the line 409 for further processing.

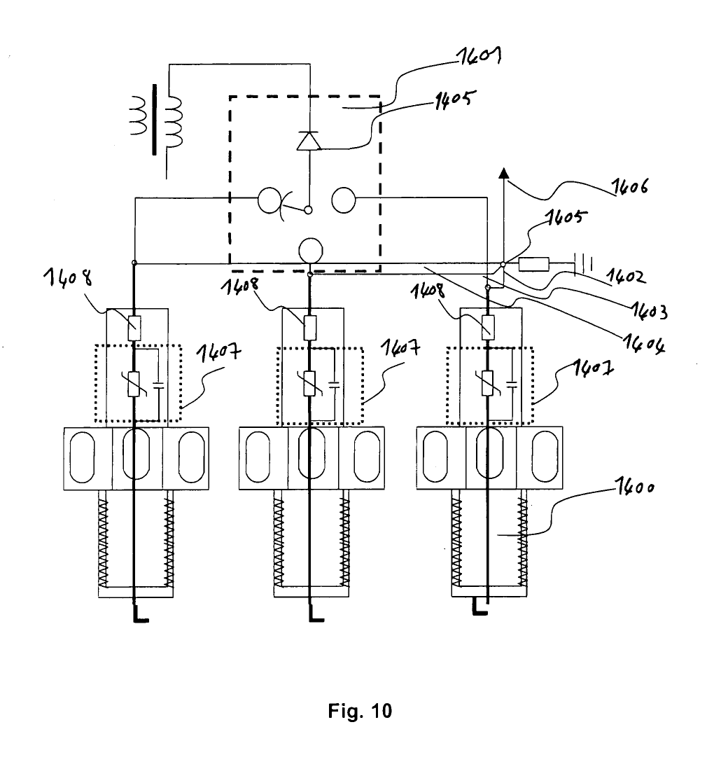

FIG. 10 shows a diagrammatic view of a plurality of spark plugs and an ignition distributor in accordance with a tenth embodiment. This shows in particular the possibility of integration of the measurement voltage storage unit 1407, the ionization measurement device 1408 and the decoupling component 1405 within the ignition distributor 1401. The measurement voltage storage device and the ionization measurement device as well as the decoupling component in accordance with a tenth embodiment can correspond to the measurement voltage storage unit, the ionization measurement device and the decoupling component in accordance with one of embodiments 1 through 9.

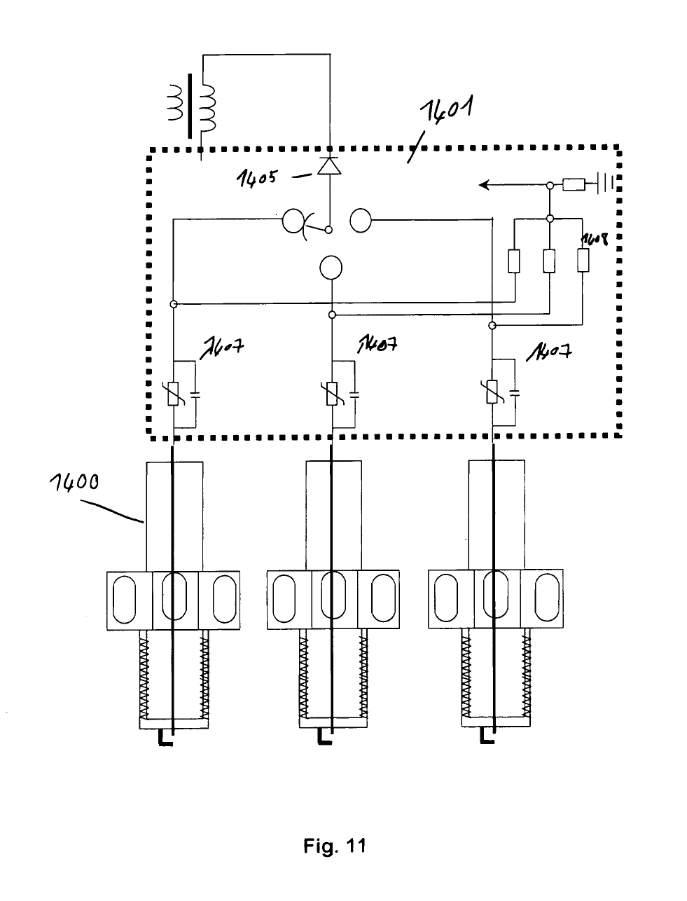

FIG. 11 shows a diagrammatic view of a plurality of spark plugs and an ignition distributor in accordance with an eleventh embodiment. In this case the measurement voltage storage units 1407 are integrated into the ignition distributor 1401. A decoupling component 1405 is coupled to a switch. A measurement voltage storage unit 1407 is associated with each spark plug.

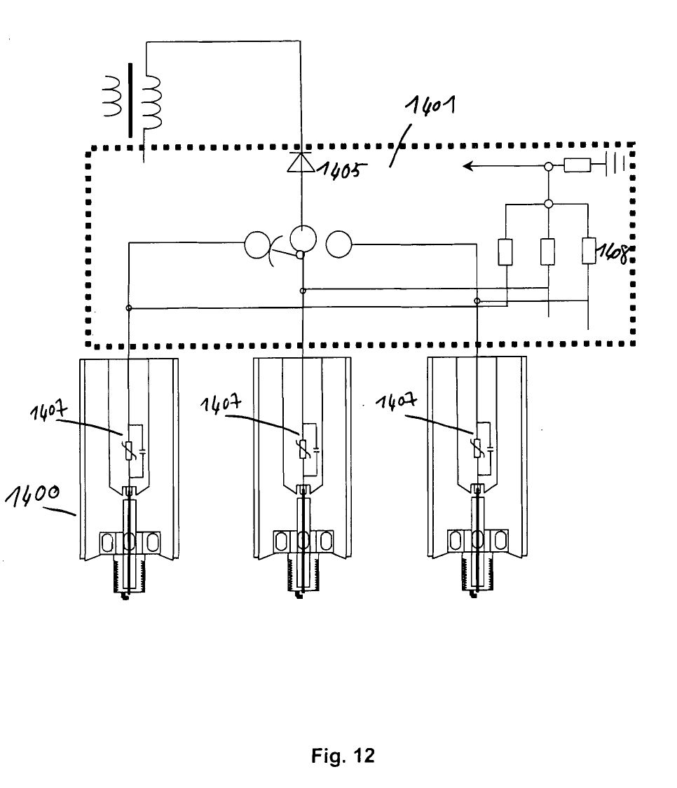

FIG. 12 shows a diagrammatic view of a plurality of spark plugs 1407 and an ignition distributor 1401 of an internal combustion engine in accordance with the twelfth embodiment. This shows in particular a multi-cylinder engine with an ignition distributor 1401, wherein the measurement detection means 1408 is integrated in the ignition distributor 1401 and the measurement voltage source 1407 is integrated in the spark plug connector. This shows in particular integration of the measurement voltage storage unit 1407 within the spark plug while the ionization measurement device and the decoupling component are disposed within the ignition distributor 1401.

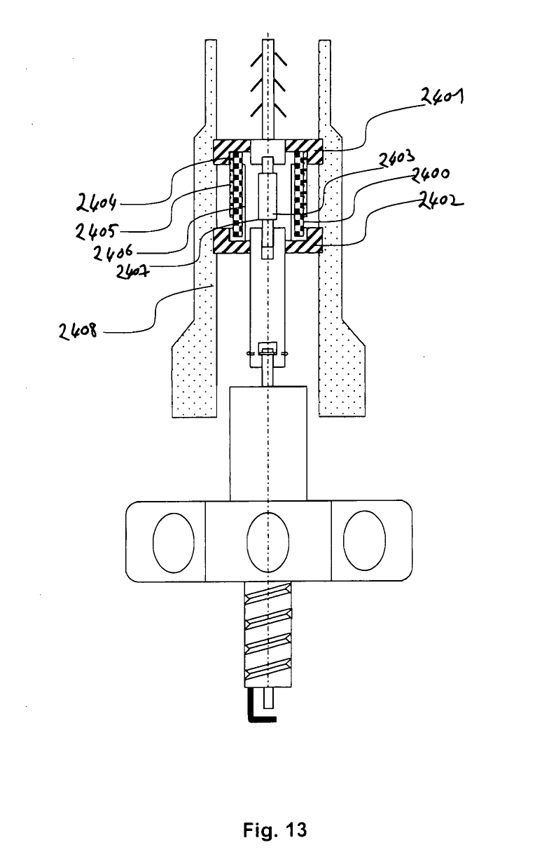

FIG. 13 shows a diagrammatic view illustrating a structure of a spark plug connector in accordance with a thirteenth embodiment. This shows in particular an advantageous design configuration for integration of the measurement voltage source within the spark plug connector or the spark plug. A tubular capacitor 2400 is used as the energy storage means. The varistor 2403 arranged axially within the tubular capacitor keeps the measurement voltage constant during the combustion phase.

The metallic contacting means 2401 and 2402 respectively serves as a mechanical receiving means of the energy storage device and forms the tubular capacitor-VDR parallel circuit.

The capacitor plates 2405 and 2406 are disposed at the inside and outside peripheries of the tube. The capacitor plates are electrically connected by means of the rotationally symmetrical metallic receiving means 2401 and 2402. The capacitor plates are separated from each other by an electrically insulating layer 2404. The intermediate space 2407 can be filled with ceramic casting material. The outer casing 2408 is made from electrically insulating material. The structure can be arranged within the ceramic insulator of a spark plug.

Although an ignition coil has been described as the ignition voltage generating device in the above-described embodiments, the ignition voltage generating device can also be embodied in another fashion. For that purpose all that is required is a device which can suitably generate a high voltage. The ignition voltage generating device serves to generate an ignition voltage. That can be effected for example by means of a piezoelectric actuator.

The circuit shown in FIGS. 1 through 3 can be implemented in a spark plug connector, in a spark plug or in an ignition distributor device. The circuit shown in FIGS. 4, 5, 6, 7 and 8 can be implemented for example in a spark plug and/or in an ignition distributor device.

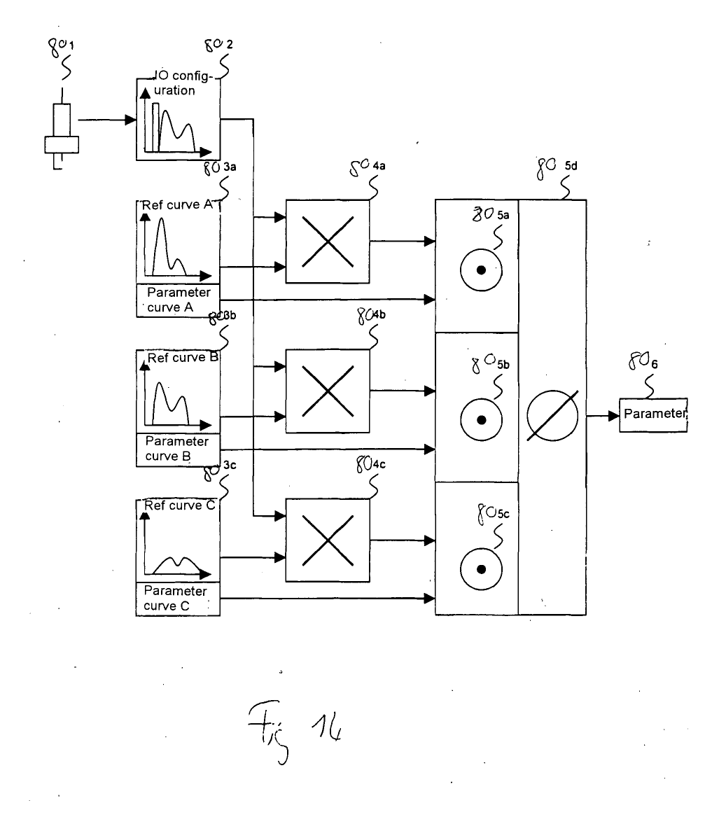

FIG. 14 shows a diagrammatic view of a circuit for the evaluation of ionization signal configurations in accordance with a fourteenth embodiment. In this case this circuit can be used together with the circuits of the first through twelfth embodiments. As an alternative thereto the circuit can also be used independently thereof. A sensor 801 is arranged in the combustion chamber of an internal combustion engine. It can advantageously be in the form of a spark plug in the case of a four-stroke spark ignition engine or in the form of an electrically conductive pin or the like in the combustion chamber of a diesel engine.

The measurement signal is amplified in a measurement amplifier 802 and possibly cleared of unwanted signal components (for example ignition residual voltage). In addition averaging of the last n ionization signals can also be effected here, in that case the averaged signal configuration is passed on. In that case the respective average value is formed from the values which have a relationship with the same reference. The reference can represent the elapsed time after the end of ignition or the crank angle or a variable which is influenced by the crank angle and time.

Averaging of a plurality of ionization signal configurations in the measurement amplifier 802 can be effected using different methods. The last n ionization signal configurations are completely stored, at each freshly arriving configuration the oldest one in the storage means is erased. All ionization values in the storage means are averaged in relation to the same point on the x-axis. That therefore then gives an averaged signal configuration in which each individual configuration is contained in a proportion of the same magnitude.

As an alternative thereto the currently prevailing ionization configuration can be calculated, with the averaged ionization configuration disposed in the storage means, so that the currently prevailing configuration updates the averaged ionization configuration in the storage means, to a certain degree. The relationship of the currently prevailing configuration of the averaged ionization configurations in the storage means gives the averaging depth.

The averaging depth can be adapted to the dynamics of the engine operating point. If the engine is in a rather stable operating condition, the averaging depth can then be increased. If however the engine is in a rather unstable operating condition the averaging depth can be reduced.

Stored in each of the reference signal storage units 803a, 803b, 803c is a respective reference ionization configuration which is to be associated with a given engine parameter value, as well as the value of the engine parameter. The number of reference signal storage units is dependent on the desired level of evaluation accuracy in respect of the engine parameter to be evaluated as well as the desired distance in relation to cross-sensitivity to other engine parameters. The number of reference signal storage units is preferably greater than or equal to two.

If the value to be evaluated of the engine parameters represents the air ratio, then by way of example a characteristic ionization signal configuration for the air ratio lambda=0.7 and as a parameter value the number 0.7 is stored in the storage unit 803a. Correspondingly, a characteristic ionization signal configuration for the air ratio lambda=1.0 is stored in the storage unit (803b) and the parameter value corresponds to the number 1.0. A characteristic ionization signal configuration for the air ratio lambda=1.5 is stored in the storage unit 803c and the parameter value corresponds to the number 1.5.

The signal configurations of the reference signal storage units 803a-803c must have the relationship to the same reference as the ionization signal configuration to be measured. The reference can be the elapsed time after the end of ignition or the crank angle or a variable which is influenced by the crank angle and time. The signal configurations can be plotted either as a function against time, a function against the crank angle or a function against a variable influenced by crank angle and time.

Generation of the reference signal configurations is described hereinafter.

A reference signal configuration is generated by operation of the engine at a reference operating mode at which the parameter value at the level of the desired value is started. The associated (averaged) ionization signal configuration is then recorded. A further reference signal configuration is generated by operation of the engine at a further reference operating mode at which the parameter value at the level of the desired value which differs from the first value is started and the associated (averaged) ionization signal configuration is then recorded. The recorded, parameter value-associated ionization signal configurations can be processed such that characteristic differences in the signal configurations are amplified. The signal configurations can further be processed in respect of suppressing unwanted parameter influences.

The correlation units 804a, 804b, 804c are fed both by the currently prevailing ionization configuration (or by an averaged ionization configuration of the last n configurations respectively) and also by the respectively associated reference signal storage units. The correlation units 804a-804c calculate the degree of conformity between the currently prevailing ionization configuration and the respectively associated reference signal configuration. That can be effected by ascertaining the degree of conformity of each value of the respective current (averaged) ionization signal configuration with the value of the reference signal configuration, that belongs to the same reference (elapsed time after the end of ignition or the crank angle). That comparison is implemented for all values and the average value of the degrees of conformity is formed.

A possible way of calculating the degree of conformity is described hereinafter.

A first step involves point-wise multiplication of the configurations of the ionization signal IO and the stored reference configurations RefA, RefB, wherein the values are multiplied together in relation to the same reference (elapsed time after the end of ignition or the crank angle). The sum from all multiplication operations is ascertained. A second step involves point-wise multiplication of the reference curve by itself and a further sum is formed from those multiplication operations. A third step involves dividing the sum from the multiplication operations of the ionization signal with the reference configuration by the sum of the multiplication operations of the reference configuration with itself, the result represents the relative degree of conformity from the respective correlation unit.

Table 1 hereinafter shows by way of example some values in respect of the reference signal configurations RefA, RefB and some points on a measured ionization curve IO. It also shows the intermediate results of the above-described method, that is to say multiplication of the ionization signal by the first reference signal, that is to say IO×RefA, and multiplication of the ionization signal by the second reference signal, that is to say IO×RefB. Multiplication of the first reference configuration RefA by itself and multiplication of the second reference signal RefB by itself are also shown.

TABLE 1

| | | | | | | Ref A* | Ref B* |
|---|---|---|---|---|---|---|---|
| Point | Ref A | Ref B | IO | IO*Ref A | IO*Ref B | Ref A | Ref B |
| 1 | 0 | 0 | 0 | 0 | 0 | 0 | 0 |
| 2 | 0.2 | 0.1 | 0.12 | 0.024 | 0.012 | 0.04 | 0.01 |
| 3 | 0.4 | 0.2 | 0.24 | 0.096 | 0.048 | 0.16 | 0.04 |
| 4 | 0.6 | 0.3 | 0.36 | 0.216 | 0.108 | 0.36 | 0.09 |
| 5 | 0.8 | 0.4 | 0.48 | 0.384 | 0.192 | 0.64 | 0.16 |
| 6 | 1 | 0.5 | 0.6 | 0.6 | 0.3 | 1 | 0.25 |
| 7 | 0.8 | 0.6 | 0.72 | 0.576 | 0.432 | 0.64 | 0.36 |
| 8 | 0.6 | 0.5 | 0.6 | 0.36 | 0.3 | 0.36 | 0.25 |
| 9 | 0.4 | 0.4 | 0.48 | 0.192 | 0.192 | 0.16 | 0.16 |
| 10 | 0.6 | 0.3 | 0.36 | 0.216 | 0.108 | 0.36 | 0.09 |
| 11 | 0.4 | 0.2 | 0.24 | 0.096 | 0.048 | 0.16 | 0.04 |
| 12 | 0.2 | 0.3 | 0.36 | 0.072 | 0.108 | 0.04 | 0.09 |
| 13 | 0 | 0.4 | 0.24 | 0 | 0.096 | 0 | 0.16 |
| 14 | 0 | 0.5 | 0.12 | 0 | 0.06 | 0 | 0.25 |
| 15 | 0 | 0.5 | 0 | 0 | 0 | 0 | 0.25 |
| 16 | 0 | 0.4 | 0 | 0 | 0 | 0 | 0.16 |
| 17 | 0 | 0.3 | 0 | 0 | 0 | 0 | 0.09 |
| 18 | 0 | 0.2 | 0 | 0 | 0 | 0 | 0.04 |
| 19 | 0 | 0.1 | 0 | 0 | 0 | 0 | 0.01 |
| 20 | 0 | 0 | 0 | 0 | 0 | 0 | 0 |
| | | | | | | Sum | Sum |
| | | | | Sum | Sum | RefA* | RefB* |
| | | | | IO*Ref A | IO*Ref B | RefA | RefB |
| | | | | 2.832 | 2.004 | 3.92 | 2.5 |

| (Sum IO* Ref A)/ | (Sum IO* Ref B)/ |
|---|---|
| (Ref A* Ref A) | (Ref B* Ref B) |
| 0.72244898 | 0.8016 |
| Proportion | Proportion |
| Ref A | Ref B |
| 0.474032652 | 0.525967348 |

Table 1 shows the reference signal configurations, in which respect the association can be implemented in relation to time or the crank angle. The Table also shows the values, which are associated with the reference (time, crank angle), of the reference signal configuration A RefA, the values, associated with the reference (time, crank angle), of the reference signal configuration B RefB, and the values, associated with the reference (time, crank angle), of the ionization signal configuration IO. The respective sums of the last four columns of Table 1 are shown therebeneath. Then, the sum of the multiplications of the ionization signal with the reference configuration are shown divided by the sum of the multiplications of the reference configuration by itself, more specifically for both reference configurations. Finally the degrees of conformity are standardised to the sum one.

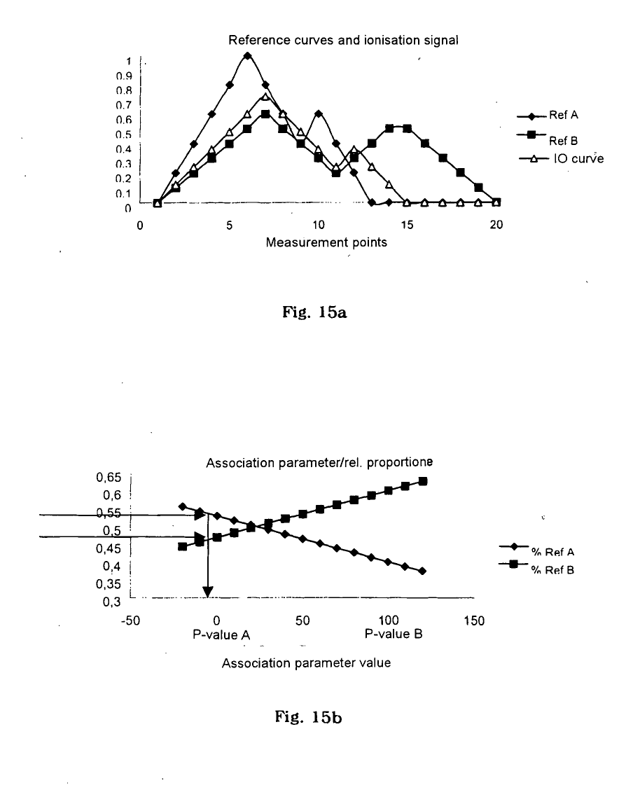

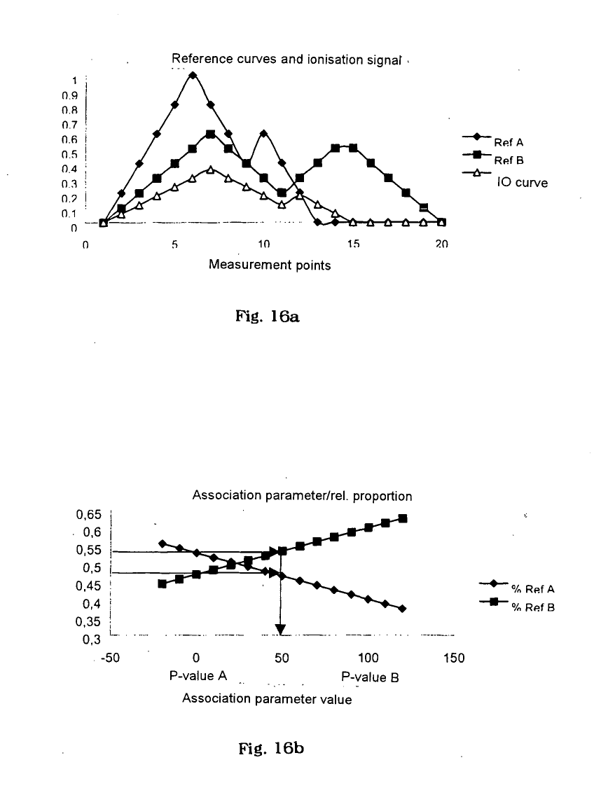

FIG. 15a shows the relative signal amplitude of the reference curves RefA; RefB and the measured ionization curve IO against a number of 20 measurement points. FIG. 15b shows the relative proportions of the measured ionization curve IO with respect to the respective reference signal configurations RefA, RefB. In the case shown in Table 1 the ionization signal has a proportion of 47% in respect of the reference signal configuration RefA and a proportion of 52% in respect of the reference signal configuration RefB.

The reference signal configuration RefA corresponds to a parameter value of lambda=1 and the reference signal configuration RefB corresponds to a parameter value of lambda=1.5. That therefore gives a lambda value of 1.24 for the measured ionization curve. The value 0 on the X-axis in FIG. 15b corresponds to a lambda value of zero. The value 100 on the X-axis corresponds to a lambda value of 1.5. Accordingly the value ascertained of about 48 corresponds to a lambda value of 1.24.

A further advantageous possible way of calculating the degree of conformity is described hereinafter.

A first step involves point-wise multiplication of the values of the configurations of the ionization signal and the reference signal in relation to the same reference (elapsed time after the end of ignition or the crank angle). The square root is extracted from the result and then the sum of all roots is formed. A second step involves forming the sum of all points of the reference configuration. In a third step the sum from the square roots of the multiplications of the ionization signal with the reference configuration is divided by the sum of the points of the reference configuration, the result is the relative degree of conformity from the respective correlation unit.

A further possible way of calculating the degree of conformity is point-wise assessment of the relative conformity (1 signifies complete conformity) of each value of the respective currently prevailing (averaged) ionization signal configuration with the value, belonging to the same reference (elapsed time after the end of ignition or the crank angle), of the reference signal configuration, and averaging of those values.

In the association units 805a, 805b, 805c, 805d, the degree of conformity calculated by the respective correlation units 804a, 804b, 804c is associated with the pertaining parameter values from the reference signal storage units 803a, 803b, 803c and calculated in dependence on the configuration of the degrees of conformity of the parameter values.

A further possible way of calculating the parameter value of the ionization signal is described hereinafter:

In a first step the respective degree of conformity from the blocks 804x is multiplied by the associated parameter value from the reference signal storage units 803x and then the sum of the multiplication operations is formed. In a second step the sum of the degrees of conformities from the blocks 804x is formed. In a third step the sum of the multiplication operations from step 1 is divided in two by the sum of the conformities from step 2. In a fourth step the result of step 3 is associated by means of an association function with the parameter value to be ascertained. The dimensioning of the association function is such that the influences of the association quality are compensated by overlaps of the reference signal configurations.

A further advantageous possible way of calculating the parameter value of the ionization signal is described hereinafter:

In a first step all degrees of conformity from the correlation units 804x are multiplied by the same factor so that after the multiplication operation the sum of the degrees of conformities is equal to one. In a second step the standardised degrees of conformity from step 1 are passed to an association table which, for a respective standardised degree of conformity from the respective correlation unit 804x, contains an association with a parameter value. In a third step the average value of all associated parameter values is formed and that is outputted as the parameter value. The association table can be designed by empirical measurements on the engine test bench with a variation in the corresponding parameter or by mathematical-geometrical calculation operations.

In accordance with a further possible option an n-dimensional matrix can be produced with relative dependencies and the associated parameter values, and the parameter value determined by interpolation. The parameter values ascertained in that way can be passed to further cyclic averaging over n working cycles of the internal combustion engine. If a plurality of different engine parameters are to be evaluated further sets of blocks 803x, 804x and 805x are implemented, matched to the evaluation of the respective engine parameter.

Table 2 hereinafter shows a further example of a further measured ionization curve, the ionization curve of Table 2 involving the same configuration as the ionization curve of Table 1, involving only half the amplitude. The configurations of the reference signals RefA and RefB correspond to those shown in Table 1.

TABLE 2

| | | | | | | Ref A* | Ref B* |
|---|---|---|---|---|---|---|---|
| Point | Ref A | Ref B | IO | IO*Ref A | IO*Ref B | Ref A | Ref B |
| 1 | 0 | 0 | 0 | 0 | 0 | 0 | 0 |
| 2 | 0.2 | 0.1 | 0.06 | 0.012 | 0.006 | 0.04 | 0.01 |
| 3 | 0.4 | 0.2 | 0.12 | 0.048 | 0.024 | 0.16 | 0.04 |
| 4 | 0.6 | 0.3 | 0.18 | 0.108 | 0.054 | 0.36 | 0.09 |
| 5 | 0.8 | 0.4 | 0.24 | 0.192 | 0.096 | 0.64 | 0.16 |
| 6 | 1 | 0.5 | 0.3 | 0.3 | 0.15 | 1 | 0.25 |
| 7 | 0.8 | 0.6 | 0.36 | 0.288 | 0.216 | 0.64 | 0.36 |
| 8 | 0.6 | 0.5 | 0.3 | 0.18 | 0.15 | 0.36 | 0.25 |
| 9 | 0.4 | 0.4 | 0.24 | 0.096 | 0.096 | 0.16 | 0.16 |
| 10 | 0.6 | 0.3 | 0.18 | 0.108 | 0.054 | 0.36 | 0.09 |
| 11 | 0.4 | 0.2 | 0.12 | 0.048 | 0.024 | 0.16 | 0.04 |
| 12 | 0.2 | 0.3 | 0.18 | 0.036 | 0.054 | 0.04 | 0.09 |
| 13 | 0 | 0.4 | 0.12 | 0 | 0.048 | 0 | 0.16 |
| 14 | 0 | 0.5 | 0.06 | 0 | 0.03 | 0 | 0.25 |
| 15 | 0 | 0.5 | 0 | 0 | 0 | 0 | 0.25 |
| 16 | 0 | 0.4 | 0 | 0 | 0 | 0 | 0.16 |
| 17 | 0 | 0.3 | 0 | 0 | 0 | 0 | 0.09 |
| 18 | 0 | 0.2 | 0 | 0 | 0 | 0 | 0.04 |
| 19 | 0 | 0.1 | 0 | 0 | 0 | 0 | 0.01 |
| 20 | 0 | 0 | 0 | 0 | 0 | 0 | 0 |
| | | | | | | Sum | Sum |
| | | | | Sum | Sum | RefA* | RefB* |
| | | | | IO*Ref A | IO*Ref B | RefA | RefB |
| | | | | 1.416 | 1.002 | 3.92 | 2.5 |

| (Sum IO* Ref A)/ | (Sum IO* Ref B)/ |
|---|---|
| (Ref A* Ref A) | (Ref B* Ref B) |
| 0.36122449 | 0.4008 |
| Proportion | Proportion |
| Ref A | Ref B |
| 0.474032652 | 0.525967348 |

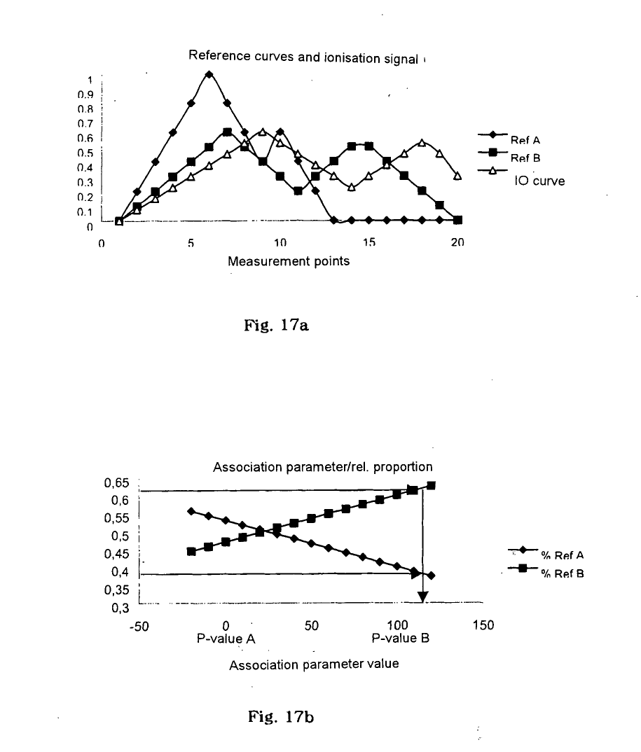

FIGS. 16a and 16b show a graph of reference signal configurations and an ionization signal as well as a graph illustrating an association of the parameters. The configuration of the reference curves RefA and RefB corresponds to the configuration of the curves shown in FIG. 15a. It can be seen from Table 2 and FIG. 16b that the association of the lambda value (here 1.24) in accordance with Table 2 and FIGS. 16a and 16b corresponds to the association in accordance with Table 1 and FIGS. 15a and 15b. As a result it can thus be said that the above-described method of ascertaining the respective parameters depends in particular on the configuration of the ionization curve and less on the amplitude of the ionization curve.

Table 3 represents some measurement values in respect of the reference signal configurations RefA, RefB, and in respect of a further measured ionization signal configuration IO. The reference signal configurations RefA, RefB correspond to those in Tables 1 and 2. The measured reference signal configuration IO partially exceeds the range of the reference signal configurations RefA, RefB.

TABLE 3

| | | | | | | Ref A* | Ref B* |
|---|---|---|---|---|---|---|---|
| Point | Ref A | Ref B | IO | IO*Ref A | IO*Ref B | Ref A | Ref B |
| 1 | 0 | 0 | 0 | 0 | 0 | 0 | 0 |
| 2 | 0.2 | 0.1 | 0.075 | 0.015 | 0.0075 | 0.04 | 0.01 |
| 3 | 0.4 | 0.2 | 0.15 | 0.06 | 0.03 | 0.16 | 0.04 |
| 4 | 0.6 | 0.3 | 0.225 | 0.135 | 0.0675 | 0.36 | 0.09 |
| 5 | 0.8 | 0.4 | 0.3 | 0.24 | 0.12 | 0.64 | 0.16 |
| 6 | 1 | 0.5 | 0.375 | 0.375 | 0.1875 | 1 | 0.25 |
| 7 | 0.8 | 0.6 | 0.45 | 0.36 | 0.27 | 0.64 | 0.36 |
| 8 | 0.6 | 0.5 | 0.525 | 0.315 | 0.2625 | 0.36 | 0.25 |
| 9 | 0.4 | 0.4 | 0.6 | 0.24 | 0.24 | 0.16 | 0.16 |
| 10 | 0.6 | 0.3 | 0.525 | 0.315 | 0.1575 | 0.36 | 0.09 |
| 11 | 0.4 | 0.2 | 0.45 | 0.18 | 0.09 | 0.16 | 0.04 |
| 12 | 0.2 | 0.3 | 0.375 | 0.075 | 0.1125 | 0.04 | 0.09 |
| 13 | 0 | 0.4 | 0.3 | 0 | 0.12 | 0 | 0.16 |
| 14 | 0 | 0.5 | 0.225 | 0 | 0.1125 | 0 | 0.25 |
| 15 | 0 | 0.5 | 0.3 | 0 | 0.15 | 0 | 0.25 |
| 16 | 0 | 0.4 | 0.375 | 0 | 0.15 | 0 | 0.16 |
| 17 | 0 | 0.3 | 0.45 | 0 | 0.135 | 0 | 0.09 |
| 18 | 0 | 0.2 | 0.525 | 0 | 0.105 | 0 | 0.04 |
| 19 | 0 | 0.1 | 0.45 | 0 | 0.045 | 0 | 0.01 |
| 20 | 0 | 0 | 0.3 | 0 | 0 | 0 | 0 |
| | | | | | | Sum | Sum |
| | | | | Sum | Sum | RefA* | RefB* |
| | | | | IO*Ref A | IO*Ref B | RefA | RefB |
| | | | | 2.31 | 2.3625 | 3.92 | 2.5 |

| (Sum IO* Ref A)/ | (Sum IO* Ref B)/ |
|---|---|
| (Ref A* Ref A) | (Ref B* Ref B) |
| 0.589285714 | 0.945 |
| Proportion | Proportion |
| Ref A | Ref B |
| 0.384078212 | 0.615921788 |

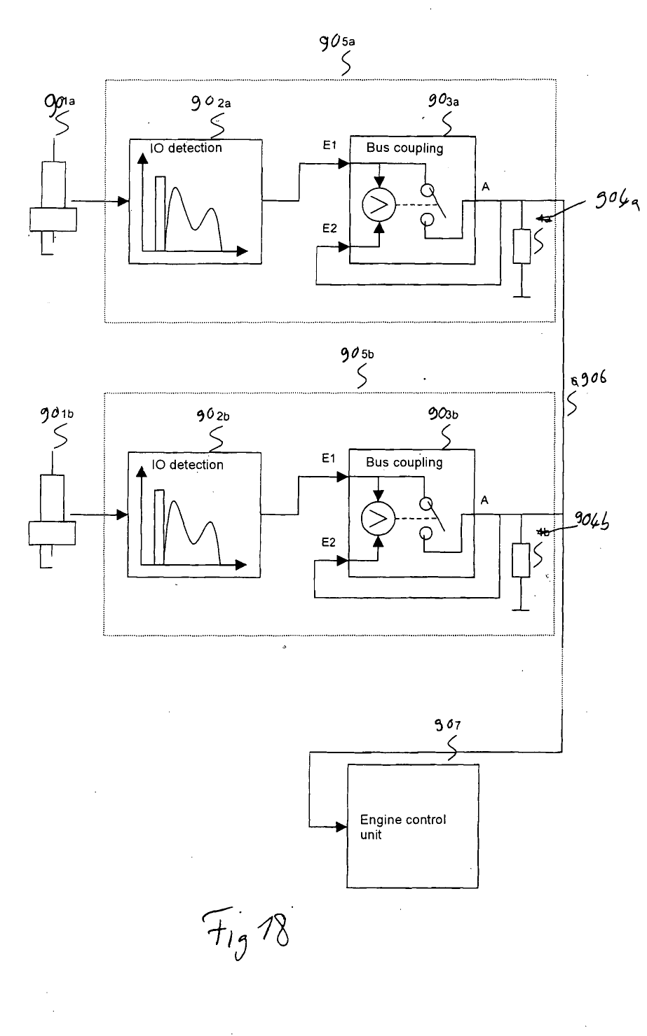

FIG. 17a shows a graph of reference curves and a measured ionization signal as well as an association of the parameters.

The above-described method enjoys the advantage that only the form of the signal configuration is crucial, independently of the absolute signal height which can vary for example due to interference parameters such as various additives in the fuel, fouling of the electrodes or the like.

While the measured ionization configuration in Tables 1 an 2 can be associated approximately in equal parts with the stored reference signal configurations RefA, RefB, thus Table 3, FIG. 17a, shows a measured ionization configuration IO which is outside the stored reference signal configurations RefA, RefB. Such a process can also be evaluated with the above-described method although the measured ionization signal is partly outside the stored reference signal configurations RefA, RefB.

The above-described method provides that the points of a reference signal configuration which is further away from the measured ionization curve are taken into account to a lesser extent in the calculation.

FIG. 18 shows a block circuit diagram of a circuit for detecting ionization signals of different cylinders. Arranged in each cylinder is a measurement sensor 901a, 901b (for example a spark plug) which produces signals and passes them to a detection unit 902a, 902b. The detection units 902a, 902b are each coupled to a respective coupling unit 903a, 903b. The coupling units 903a, 903b are each connected by way of an ionization signal transmission line 906 to an engine control system 907. The outputs of the coupling units 903a, 903b are each coupled to the signal ground by way of a terminal resistor 904a, 904b.

Based on the realisation that the ionization signals usually occur in time-displaced relationship in multi-cylinder engines the signals of a plurality of cylinders can be combined for evaluation and coupled by way of coupling units to an ionization signal transmission line and outputted to an engine control system.

The coupling means 903a, 903b switches the output of an ionization signal detection unit 902a, 902b to the common transmission line 906 when the ionization value at the output of the detection unit 902a, 902b is larger in terms of its magnitude than the value at the common transmission line 906. Thus the coupling unit 903a, 903b compares the output value of the detection unit 902a, 902b to the instantaneous value of the common transmission line 906.

As an alternative thereto the coupling unit 903a, 903b switches the output of the detection unit 902a, 902b to the common ionization signal transmission line 906 during a period of time after the end of ignition of the respective cylinder or during a defined period of time after the end of ignition, that is to say during the period during which an evaluatable ionization signal is assumed to occur.

Preferably the detection unit 902a, 902b associated with a respective cylinder and the coupling unit 903a, 903b are respectively disposed in the same housing 905a, 905b (for example in a rod-type ignition coil). In addition or alternatively thereto all coupling units which are connected to a common ionization signal transmission line 906 can be disposed in a common housing.

While the foregoing description and drawings represent the present invention, invention, it will be obvious to those skilled in the art that various changes may be made therein without departing from the true spirit and scope of the present invention.

What is claimed is:

1-48. (canceled)

49. A circuit for detecting combustion-relevant variables in a combustion phase of an internal combustion engine, in particular a four-stroke engine, wherein the combustion phase is triggered by an ignition electrode supplied with an ignition pulse, comprising:
an ionization measurement circuit having at least one measurement resistor;
said ionization measurement circuit having at least one measurement voltage storage unit which is coupled to the ignition electrode and is decoupled by way of decoupling means from an ignition voltage generating device.

50. The circuit of claim 49 wherein said ignition voltage generator device is an ignition coil.

51. The circuit as set forth in claim 49 wherein the measurement voltage storage unit comprises an electrical energy-storing component and a voltage-limiting component.

52. The circuit as set forth in claim 51 wherein the electrical energy-storing component is a capacitor and the voltage-limiting component is a varistor, a Zener diode, a spark gap or a gas arrester.

53. The circuit as set forth in claim 49 wherein the measurement resistor is in the form of a series circuit of resistors.

54. The circuit as set forth in claim 49 wherein the decoupling means comprises a voltage-limiting component.

55. The circuit as set forth in claim 54 wherein the voltage-limiting component is a varistor, a Zener diode, a spark gap and/or a gas arrester.

56. The circuit as set forth in claim 49 wherein the decoupling means has a resistor connected in parallel with the ignition coil for damping the decay process of the ignition coil.

57. The circuit for detecting combustion-relevant variables of an internal combustion engine comprising an ionization measurement device and at least one ionization measurement resistor, in particular as set forth in claim 49, wherein a measurement voltage storage circuit is connected between a first ignition voltage-carrying connection of the secondary side of the ignition transformer and the ignition electrode and that an electronic switch is connected between a reference potential and the second connection, associated with the reference potential, of the secondary side of the ignition transformer.

58. The circuit as set forth in claim 57 wherein a further decoupling device is connected between the ignition voltage-carrying connection of the secondary side of the ignition transformer and the ignition measurement circuit.

59. The circuit as set forth in claim 58 wherein the decoupling device has a diode, a Zener diode and/or a varistor.

60. The circuit as set forth in claim 57 wherein the measurement voltage storage circuit comprises a parallel circuit of a voltage-stabilizing component and a voltage-storing component.

61. The circuit as set forth in claim 57 wherein the electronic switch is coupled by way of coupling components to the current path of the primary circuit of the ignition transformer.

62. The circuit as set forth in claim 57 wherein a coupling element for compensation purposes is connected between the connection, associated with the reference potential, of the secondary side of the ignition transformer and the ionization measurement output.

63. The circuit as set forth in claim 62 wherein the coupling element is a resistor, a resistor/capacitor combination or an amplifier stage.

64. The method of detecting combustion-relevant variables of a combustion process in a combustion phase of an internal combustion engine comprising the steps of:
initiating individual combustion processes by an ignition pulse;
ascertaining the combustion-relevant variables in dependence on an ionization signal influenced by the flame;
building up a voltage potential in a measurement voltage storage unit in the ignition phase by an ignition current; and
applying a voltage potential in at least one measurement phase by way of a measurement resistor to an ignition electrode, wherein the ignition voltage is decoupled from the measurement voltage storage unit or the measurement resistor in respect of the measurement voltage when the voltage falls below a threshold voltage.

65. The method as set forth in claim 64 including the method step that the voltage which is proportional to the ionization signal is taken off at one of the resistors and passed to an evaluation unit.

66. The method of detecting combustion-relevant variables in the combustion phase of an internal combustion engine by an ignition electrode supplied with an ignition pulse, in particular as set forth in claim 64, with an ionization measurement circuit, and for ionization measurement with a measurement voltage applied to the ignition electrode at least subsequently to ignition;
wherein the ionization measurement circuit is connected between the ignition voltage-carrying connection of the secondary side of the ignition transformer and the ignition electrode; and
an electronic switch is connected between the reference potential and a connection, associated with the reference potential, of the secondary side of the ignition transformer is an electronic switch which is switched into a conducting condition by a control unit during the ignition pulse for passing the ignition signal and is switched into the non-conducting condition at least during the ionization measurement phase.

67. The method as set forth in claim 66 including the method step that the control unit switches the electronic switch into the non-conducting condition at least during the duration of switching off the ignition pulse, wherein the electronic control system is provided with means for switching off the ignition pulse by low-impedance loading of the primary winding of the ignition transformer.

68. The method as set forth in claim 67 including the method step that the control unit already switches the electronic switch into the non-conducting condition shortly before the ignition pulse is switched off.

69. An ignition transformer comprising a circuit for detecting combustion-relevant variables of an internal combustion engine comprising an ionization measurement device and at least one ionization measurement resistor, as set forth in claim 49, wherein the measurement voltage storage circuit is connected between the ignition voltage-carrying connection of the secondary side of the ignition transformer and the ignition electrode and that an electronic switch is connected between a reference potential and the connection, associated with the reference potential, of the secondary side of the ignition transformer.

70. A device for the ignition of combustion processes in internal combustion engines comprising a spark plug for the ignition of combustion and the spark plug as a sensor for ionization caused by combustion, having an ionization measurement circuit for measuring ionization in the combustion chamber, an evaluation unit for the ionization measurement values and means for generating an ignition voltage, wherein means for controlling the ignition voltage configuration is connected to the ionization evaluation unit and the ignition voltage configuration is controlled or regulated in dependence on the ionization measurement values of at least a part of at least one combustion cycle.

71. The device as set forth in claim 70 wherein said means for generating the ignition voltage include at least one ignition transformer having a primary winding and a secondary winding, a semiconductor switch connected to the primary winding and a supply voltage source, wherein the semiconductor switch is actuated by said means for controlling the ignition voltage configuration and connects a supply voltage source to the primary winding of the ignition transformer.

72. The device as set forth in claim 70 wherein the evaluation unit for the ionization configurations is connected to the ionization measurement circuit and the ionization measurement values are evaluated having regard to ignition of the mixture in the combustion chamber.

73. A method of igniting a fuel-air mixture during a combustion cycle in an internal combustion engine, comprising the steps of:
producing a first ignition pulse which is followed by an ionization measurement operation;
comparing measured ionization signals to ionization reference values; and
triggering no or at least one further ignition pulse in dependence on the comparison.

74. The method as set forth in claim 73 wherein no further ignition pulse is produced if ignition of the mixture is detected as the result of the comparison.

75. The method as set forth in claim 73 wherein ignition of the mixture is detected if the ionization measurement value exceeds a parametrized value in a parametrized time interval subsequently to the termination of the ignition voltage pulse.

76. The method as set forth in claim 73 wherein the first ignition pulse is controlled in dependence on the operating point of the internal combustion engine.

77. The method as set forth in claim 73 wherein the ignition voltage configuration is controlled or regulated in dependence on the ionization measurement values of the current combustion cycle.

78. The method as set forth in claim 73 wherein the ignition voltage configuration is effected in dependence on the ionization measurement values of at least one preceding combustion cycle.

79. The method as set forth in claim 73 wherein the ignition voltage configuration is controlled or regulated in dependence on the ionization measurement values of the current and preceding combustion cycles.

80. The method and device as set forth in claim 73 wherein the unit for controlling the ignition voltage configuration for terminating the ignition pulse on the secondary winding of the ignition transformer actuates the semiconductor switch so that the supply voltage source is connected to the primary winding of the ignition transformer.

81. An ignition coil unit comprising:
a primary winding and a secondary winding in which a high voltage is generated for ignition of the mixture; and
an ionization measurement circuit being integrated into the ignition coil unit, said ionization measurement circuit being connected by way of an evaluation unit for the ionization measurement values to a means for controlling the ignition voltage configuration and the ignition voltage configuration being controlled or regulated in dependence on the ionization measurement values of at least a part of at least one combustion cycle.

82. The ignition coil unit comprising:
a primary winding and a secondary winding in which a high voltage is generated for ignition of the mixture;
an ionization measurement circuit being integrated into the ignition coil unit, said ionization measurement circuit being connected by way of an evaluation unit for the ionization measurement values to a means for controlling the ignition voltage configuration and the ignition voltage configuration being controlled or regulated in dependence on the ionization measurement values of at least a part of at least one combustion cycle; and further comprising:
an ignition device as set forth in claim 70.

83. The ignition coil unit as set forth in claim 81 wherein the evaluation unit for the ionization measurement values is integrated into the ignition coil unit.

84. The ignition coil unit as set forth in claim 81 wherein said means for controlling the ignition voltage configuration are integrated into the ignition coil unit.

85. The ignition coil unit as set forth in claim 81 wherein a semiconductor switch is integrated into the ignition coil unit and the semiconductor switches the primary winding of an ignition transformer to the supply voltage in dependence on the evaluated signals of the evaluation unit for ionization measurement values.

86. An engine control system for the ignition of combustion processes in internal combustion engines and for detecting ionization signals comprising:
an ionization measurement circuit for measurement of ionization in the combustion chamber, an evaluation unit for the ionization measurement values; and
means for generating an ignition voltage;
wherein means for controlling the ignition voltage configuration is connected to the ionization evaluation unit and the ignition voltage configuration is controlled or regulated in dependence on the ionization measurement values of at least a part of at least one combustion cycle.

87. An ignition device for internal combustion engines comprising:
an ignition coil for ignition of a spark plug of the internal combustion engine;
an ignition unit for initiating ignition of the ignition coil in accordance with an external ignition triggering signal from an external engine control unit;
an ionization detector for detecting an ionization signal of combustion of the internal combustion engine and for outputting an ionization measurement signal which is proportional to the ionization signal; and
coupling means for selectively coupling the ionization measurement signal and the ignition triggering signal to an ignition/ionization line which connects the ignition device to the external engine control unit.

88. The ignition device as set forth in claim 87 wherein the coupling means has a first path for passing the ignition triggering signal and a second path for passing the ionization signal, wherein the first path is adapted to be conducting for the ignition triggering signal and non-conducting for the ionization measurement signal, and wherein the second path is adapted to be conducting for the ionization measurement signal and non-conducting for the ignition triggering signal.

89. A spark plug connector comprising a circuit for detecting combustion-relevant variables as set forth in claim 49.

90. A spark plug connector comprising a circuit for detecting combustion-relevant variables in a combustion phase of an internal combustion engine, in particular a four-stroke engine, wherein the combustion phase is triggered by an ignition electrode supplied with an ignition pulse, comprising:
an ionization measurement circuit having at least one measurement resistor;
said ionization measurement circuit having at least one measurement voltage storage unit which is coupled to the ignition electrode and is decoupled by way of decoupling means from an ignition voltage generating device and/or a device for the ignition of combustion processes as set forth in claim 70.

91. An engine ignition device for the ignition of combustion processes in an internal combustion engine comprising:
a spark plug as set forth in claim 90; and
an ignition distributor device having a decoupling component.

92. An engine ignition device for the ignition of combustion processes in an internal combustion engine comprising:
a plurality of spark plugs; and
an ignition distributor device, wherein the ignition distributor device has at least one circuit for detecting combustion-relevant variables as set forth in claim 49;
wherein the ignition distributor device has a decoupling component, and wherein measurement resistors are coupled with a common star point.

93. A circuit for the evaluation of ionization signal configurations of combustion in an internal combustion engine, comprising:
an ionization signal measurement unit for measuring an ionization signal configuration;
at least two reference signal storage units for the storage of previously recorded reference signal configurations and for the storage of a parameter value associated with the reference signal configuration;
at least two correlation units for correlating the measured ionization signal with at least a first and a second stored reference signal configuration by determining the degree of conformity between the measured ionization signal and the stored reference signal configurations; and
at least two association units for association of the conformity calculated by the correlation units with the associated stored parameter values of the stored reference signal configurations.

94. A circuit as set forth in claim 93 wherein the correlation units multiply each value of the ionization signal configuration by the corresponding value of one of the reference signal configurations and output the result to one of the association units.

95. A circuit as set forth in claim 94 wherein the association units multiply each value of the reference signal configuration by itself and sum the results of the correlation unit and the results of multiplication of the reference signal configuration, wherein the sum of the multiplication of the values of the ionization curve by the corresponding values of the reference signal configuration is divided by the sum of the multiplication of the points of the reference signal configuration by themselves.

96. A method of evaluating ionization signal configurations of combustion in an internal combustion engine, comprising the steps of:
measuring an ionization signal configuration;
storing at least two previously recorded reference signal configurations and a parameter value associated with the reference signal configuration;
correlating the measured ionization signal with the at least two stored reference signal configurations by determining the degree of conformity between the measured ionization signal and the stored reference signal configurations; and
associating the conformity calculated by the correlation with the associated stored parameter values of the stored reference signal configurations.

97. A device for detecting ionization signals of at least two cylinders of an internal combustion engine, comprising:
a detection unit which is respectively coupled to an ionization measurement sensor for detection of the ionization signals;
at least one coupling unit which couples the detection unit to a respective ionization signal transmission line;
wherein the coupling unit couples the output signal of the detection unit to the ionization signal transmission line when the magnitude of the ionization signal at the output of the detection unit is greater than the magnitude of the ionization signal transmission line, or wherein the coupling unit couples the output of the detection unit to an ionization signal transmission line during a defined period of time after the end of ignition of the respective cylinder.

98. The device as set forth in claim 97 wherein the detection unit and the coupling unit are arranged in a common housing.

99. The device as set forth in claim 97 wherein the coupling units are arranged in a common housing.
